(19) United States
(12) Patent Application Publication
(10) Pub. No.: US 2003/0069966 A1
(43) Pub. Date: Apr. 10, 2003

(54) Method and system for directing users to information specific to network applications

(76) Inventors: Peter B. Ritz, Meadowbrook, PA (US); David Isherwood, Staten Island, NY (US); Christopher J. Tilghman, Philadelphia, PA (US); Roger Skagerwall, Enskede (SE)

Correspondence Address: Daniel H. Golub, 1701 Market Street, Philadelphia, PA, 19103, US

(21) Appl. No.: 09/974,711

(22) Filed: Oct. 10, 2001

(51) Int. Cl. G06F 15/173; G06F 17/30

(52) U.S. Cl. 709/225; 707/10

(57) ABSTRACT

A user is directed to information specific to an application on a network upon inputting a first number uniquely identifying the application on the network and, in some cases, a second number associated with the information.

This application is a continuation-in-part of U.S. Patent Application entitled “Method and System for Directing End User To Selected Network Location of Provider Based on User Provided Codes” filed Oct. 4, 2001.

### FIELD OF THE INVENTION

The present invention relates to directing an end user to information specific to an application on a network.

### BACKGROUND OF THE INVENTION

Every day, millions of individuals use numbers to obtain the information they desire. For example, such individuals employ telephone numbers to make calls, order numbers to track packages, flight numbers to check arrivals and departures, or credit card numbers to make purchases or check balances. While use of numbers in prior art systems simplifies to some extent obtaining personalized and other desired information, these systems suffer from a number of deficiencies. First, users must access a each application from which it seeks information at a different location. For example, users must call different telephone numbers to access different credit card companies to obtain account balances or visit different airline web sites to obtain flight information. Further, gaining access to the specific information desired by the user typically requires that the user follow several disconnected paths and involves the user taking two or more steps. For example, the user must first dial a telephone number to obtain a directory; then, make at least one selection from the directory; and, finally, enter the user's account number to obtain the desired information—the account balance. By way of further example, the user may be required to obtain pieces of information from several different locations to obtain the ultimate information they desire. Thus, there exists a need for a system that allows a user to manage and utilize, effectively and efficiently, numbers to obtain desired information.

### SUMMARY OF THE INVENTION

The present invention provides systems and methods for directing a user to information specific to an application on a network.

In particular, the present invention is directed to a method and system for directing a user to information specific to an application on a network. At least one first number uniquely identifying the application on the network is received at a first site. The first number is issued by an entity that maintains a first registry of first numbers uniquely identifying applications on the network. At least one second number associated with the information is also received. The second number is issued by an application provider. The first number and the second number are entered by the user at a single point of input. At least the first number is applied to an index maintained at the first registry to identify a location of the application on the network. The user is automatically directed to the information based on a combination of the first number and the second number by applying an output of the first registry to a second registry. The second registry is different from the first registry.

The present invention is further directed to another method and system for directing a user to information specific to an application on a network. At least one first number uniquely identifying the application on the network and at least one second number associated with the information are entered by the user at one of a plurality of input points located at different locations on the network and received at a first site. The first number is issued by an entity that maintains a first registry of first numbers uniquely identifying applications on the network. At least the first number is applied to an index maintained at the first registry to identify a location of the application on the network. The user is automatically directed to the information based on a combination of the first number and the second number by applying an output of the first registry to a second registry. The second registry is different from the first registry.

The present invention is also directed to a further method and system for directing a user to information specific to an application on a network. A user input comprising at least one first number uniquely identifying the application on the network is entered by the user at one of a plurality of input points located at different locations on the network and is received at a first site. The first number is issued by an entity that maintains a first registry of first numbers uniquely identifying applications on the network. A provider offering the application is required to host at least one of the input points on a provider site. At least the first number is applied to an index maintained at the registry to identify a location of the application on the network. The user is automatically directed to the information based on the user input by applying an output of the first registry to a second registry. The second registry is different from the first registry.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1A illustrates a preferred embodiment of a system for carrying out the methods of the present invention.

FIG. 1B illustrates an example of service numbers issued in accordance with one embodiment of the present invention.

FIG. 2 illustrates a preferred embodiment of a system for carrying out the methods of the present invention.

FIGS. 3A and 3B illustrate alternative information flows that may be used in accordance with a preferred embodiment of the present invention.

FIG. 4 illustrates a preferred embodiment of a system for carrying out the methods of the present invention.

FIGS. 5A through 5E illustrate examples of the way in which a preferred embodiment of the system of the present invention may be implemented.

FIGS. 6A through 6C depict flow charts illustrating preferred embodiments of a method for directing a user to information specific to an application on a network.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

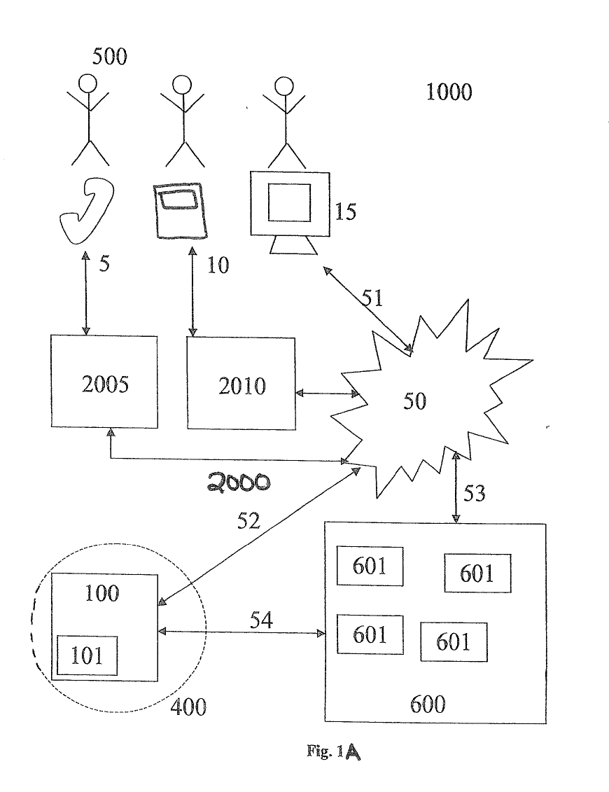

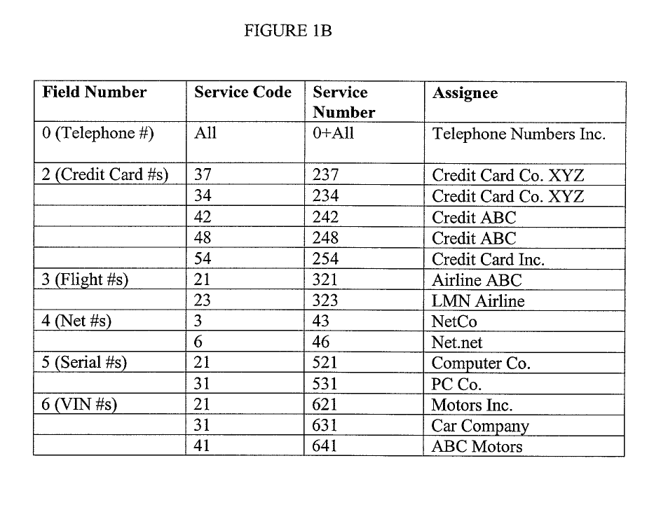

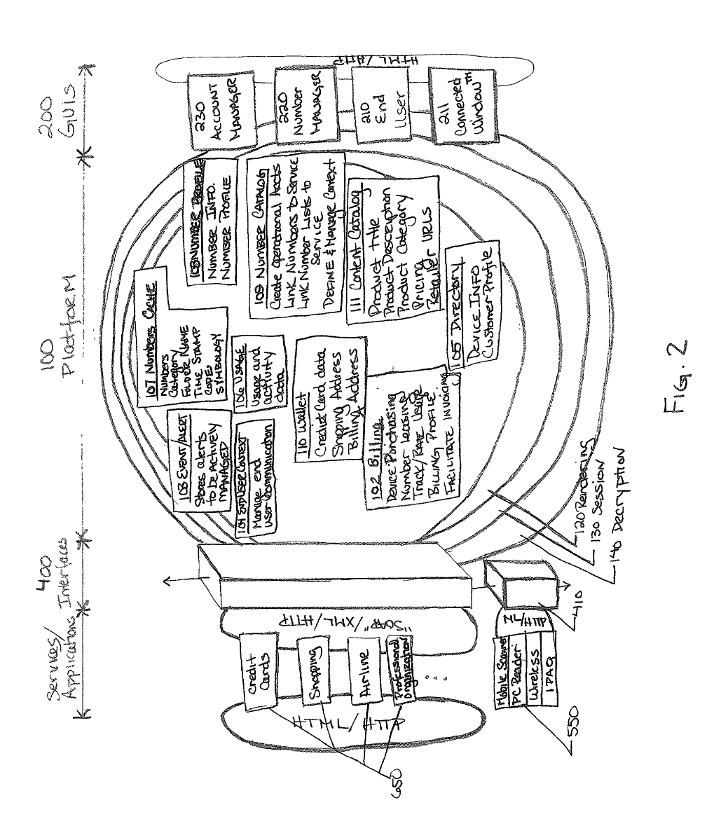

FIG. 1A illustrates a preferred embodiment of a system 1000 for carrying out the methods of the present invention. System 1000 includes a plurality of end users 500, each with a device. System 1000 also includes platform 100 and a plurality of providers 600. Providers 600 each host a provider site 601 accessible via the Internet 50. Providers 600 are organizations that offer services/applications, such as credit card companies, airlines, shopping services and professional organizations. Platform 100 comprises multiple components (described more fully with reference to FIG. 2) that facilitate the interoperability between end users 500 (and their associated devices) and the applications of providers 600. Platform 100 has a wide range of functionality, as described in more detail herein, but primarily functions as a switch, identifying numbers, user context and application information necessary for launching services that assist end users 500 in obtaining the information they desire. Platform 100 includes a hub site 101 accessible via the Internet 50, which allows end users 500 and providers 600 to interact with platform 100.

End users 500 employ various devices (described in more detail below) to input numbers that represent an application of providers 600 (for example, an application hosted on one of providers sites 601) on network 2000 and, in some embodiments, information specific to that application. In particular, the numbers inputted by end user 500 include, in the preferred embodiment, a service number, which uniquely represents the application on the network 2000. In the preferred embodiment, the service number includes multiple digits that indicate both the field of the application and the specific entity to which the service number applies. For example, the digit 3 may be used to indicate the airline industry and the digits 21 may represent a particular airline. Thus, the service number 321 would be the service number assigned to a Airline XYZ, for example. In other embodiments, one or more digits of the service number may indicate the industry, or entity within an industry, and one or more other digits of the service number may indicate a specific user need being satisfied. For example, the digit 3 may represent a particular airline and the digits 21 may represent the checking of flight arrivals for that airline. Other methods of identifying and assigning service numbers (including random generation) may be used within the scope of the present invention. FIG. 1B illustrates an example of service numbers issued to various entities.

In one embodiment, end user 500 learns of the service number for a particular provider 600 by consulting a list of service numbers maintained by a registry (i.e., platform 100). In an alternate preferred embodiment, the service number is printed on an article associated with provider 600. For example, the service number for a particular credit card company may be printed on a user's credit card. In another example, the service number for a particular airline may be printed on a user's airline ticket.

In another preferred embodiment, the user enters an identification number, following the service number. The identification number is associated with information specific to the application identified by the service number. For example, the identification number may be a flight number associated with a particular airline; a credit card number associated with a particular credit card company; or a registration number associated with a particular professional association.

In the preferred embodiment, the service number and the identification number are entered by the user at a single user input point, and are separated by a delimiter. In some embodiments, both the service number and the identification number are entered in a single user input, although in other embodiments they may be entered in more than one input. Where the service number and the identification number are entered in multiple user inputs, use of a symbol or number as a delimiter may not be necessary. Where a delimiter is used, it may be a symbol such as a pound sign (also referred to as a hash or sharp) or may be a number that is designated as the delimiter. In this embodiment, the number designated as the delimiter should not also be used as part of a service number. Thus, in one embodiment, all service numbers listed in the registry end with a common digit, for example, the digit “7”. In this embodiment, a user can enter both the service number and the identification number by only accessing numeric keys on a system key pad. When platform 100 receives the combination of the service number and the identification number, it can easily delineate both segments, through identification of the common delineator, e.g., the digit “7”. This embodiment may be particularly advantageous in situations where a WAP-enabled phone is used as the input device, but may be unnecessary for situations in which a personal computer is used as the input device.

The combination of the service number and the identification number are then used by platform 100 to direct the user to the specific information desired. For example, a user entering a service number corresponding to Airline ABC and a flight number 111 may be directed to information relating to, for example, the scheduled time and cities of departure and arrival for flight number 111 of Airline ABC. In the preferred embodiment, the information to which the user is directed may be different depending on several context factors (e.g., the language used by the user, the device used to input the number and the location of the user), as described in more detail below.

End users 500 may employ a variety of different types of devices to input numbers and communicate such numbers to platform 100. For example, end users 500 may contact platform 100 by telephone 5 and input the numbers by dialing or may speak the numbers into the handset. This input is transmitted though voice gateway 2005 to Internet 50 and then to a voice response unit at platform 100 or at providers 600. End users 500 may also use a personal digital assistant 10 and transmit numbers through wireless application protocol gateway 2010, to Internet 50, and then to platform 100 or providers 600. Alternatively, the end users 500 may use client 15 to input numbers, which are then transmitted through the Internet 50 and to platform 100. Other means of inputting numbers and transmitting them to platform 100 or providers 600 are known in the art and are within the scope of the present invention. The particular device used by end user 500 may dictate the functionality of system 1000 that will be enabled, as discussed in more detail below.

End users 500, platform 100, and providers 600 may connect to each other through a variety of different types of links to form network 2000. For example, end users 500 may connect to platform 100 through the Internet 50, directly through link 51 and link 52, or by way of provider 600, though link 51, link 53 and link 54. In other embodiments, alternate configurations of the connections between end users 500, platform 100 and providers 600 are possible, will be known to those skilled in the art and are within the scope of the present invention. In some embodiments, one or more of the links between these various entities is wireless.

At least one interface 400 is disposed between platform 100 and the remainder of system 1000. Access to platform 100 is controlled through interfaces 400. In particular, for example, interfaces 400 monitor and provide security of communications between platform 100 and the remainder of the system 1000, as well as convert data transmitted to and from platform 100. Thus, interfaces 400 are the external boundary of platform 100.

FIG. 2 illustrates a further preferred embodiment, including more detail, of the system 1000 shown in FIG. 1A. With reference to both FIGS. 1A and 2, services/applications 650 represent services and applications offered within system 1000 by providers 600 from which end users 500 seek information. Exemplary services/applications 650 shown in FIG. 2 include shopping services, credit card services, airlines, and professional organizations. However, information from any type of web service/application 650 could be sought using system 1000 within the scope of the present invention. As described previously with reference to FIG. 1A, end users 500 may employ a variety of devices 550 to communicate information to and receive information from system 1000.

One or more interfaces 400, which provide the means by which providers 600 and end users 500 may access the information and functionality of platform 100, may be expressed as SOAP-like envelopes with XML payload using HTTP transport of TCP/IP, in the preferred embodiment. All interface calls to the platform 100, in the preferred embodiment, require credentials and authentication. Also, in cases in which privacy is a concern, encryption may be employed.

Platform 100 performs a number of services that are not identified with any particular component. For example, platform 100 performs a rendering service 120 that enables output of data to end user 500 regardless of the class of device being used by end user 500. This is accomplished by making adjustments to support specific protocols and by making allowances for the physical display geometry and input mechanism of a particular device, through rendering interface 410. Thus, for example, end users 500 will be able to receive output from system 1000 that is appropriate for the particular device being used by end user 500 (i.e., PCs (large devices), web enabled phones (small devices), or PDAs (medium devices)). In the preferred embodiment, providers 600 are responsible for supplying appropriate output for each class of device in order to take advantage of the rendering services 120 of platform 100.

Session service 130 of platform 100 ensures continued user connection and authentication within a single application sign on. End users 500 using system 1000 navigate across disparate systems owned and ran by different organizations and, thus, session service 130 is provided to ensure that the experience of the end user 500 is contiguous. Session service 130 defines the parameters passed from/to external services 650 to/from the platform 100 as an end user 500 passes from one to the other. These parameters may include the following: service identification; the end user identifier; session echo data (i.e., information that the platform 100 has indicated if wants back from the external service 650 when the user returns to the platform 100); external echo data (i.e., information the external service 650 has indicated it wants from the platform 100 when the end user returns to the external service 650); a ticket associated with a batch of numbers; a time stamp; and a digest that is computed based on the values of the foregoing parameters.

Platform 100 also includes, in the preferred embodiment, decryption service 140. Decryption service 140 allows device-specific decryption of numbers and other application data if required. In other embodiments of the present invention, the session, rendering and decryption functions could be carried out by one or more of the providers 600, rather than by platform 100.

In addition to the session, rendering and decryption services performed by platform 100, platform 100 is comprised of a number of different components, in the preferred embodiment. Each component stores particular information and has certain functionality. The functionality supported by the components of platform 100 can be grouped into four main categories, in the preferred embodiment: (1) processing of numbers inputted by users, which includes authenticating numbers, devices, and users; receiving and encrypting/decrypting numbers, if necessary; and mapping numbers to applications; (2) managing numbers lists, which includes adding, removing and editing numbers; and copying, cutting, pasting, and clearing lists of numbers; (3) administrating numbers and associated applications, which includes the buying and retiring of numbers; and restricting/granting access to numbers; and (4) monitoring events and usage, which includes monitoring event mechanisms and accessing number input histories for each user and each device.

Providers 600 and end users 500 may access and use the components of platform 100 via a hub site 101, maintained on the Internet by platform 100, using graphical user interfaces (“GUIs”) 200. End user GUI 210 is a generic interface through which end users 500 gain access to the information and functionality of platform 100. Alternatively, end users 500 may gain access to the platform 100 through connected window™ GUI 211. Connected window™ GUI 211 represents one of a plurality of input points located at different locations on the network 2000. For example, a connected window™ GUI 211 may be found on any provider site 601 or on the hub site 101 (with reference to FIG. 1A). In the preferred embodiment, end user context component 104, number profile component 108, event/alert component 103, usage component 106, number cache component 107 and directory component 105 may be accessed through end user GUI 210 or connected window™ GUI 211.

Number manager GUI 220 can be used by providers 600 to set up and edit services/applications 650; register service numbers and identification numbers; create and edit number lists (e.g., lists of numbers and their associated data, such as descriptions, used to link the numbers to particular URLs of services/applications 650); and assign context to services, such as locale-specific display, display language, and output device channel (e.g., small for mobile phone browser, medium for PDA browser and large for PC browser). Number catalog component 109, directory component 105, and billing component 102 may be accessed by number manager GUI 220, in the preferred embodiment.

Account manager GUI 230 allows for the set up of various business relationships with providers 600. In the preferred embodiment, billing component 102 may be accessed through account manager GUI 230.

The following describes the content and functionality of each component of the platform 100 in a preferred embodiment of the present invention. Additional or less information and/or functionality may be included in the components described below in other embodiments within the scope of the present invention.

Billing component 102 of platform 100 facilitates invoicing and payment processing. Event/alert component 103 allows for storage of application and business events that should be actively managed to ensure the integrity of data stores and business flows. In particular, this component tracks end user 500 behaviors and provides the mechanism to initiate proactive actions based on the profile of the end user 500. For example, event/alert component 103 may identify potentially fraudulent behavior on behalf of an end-user 500 within system 1000 and proactively intervene. Usage component 106 is used to track usage of system 1000 by end users 500.

End user context component 104 manages communication between platform 100 and end users 500 as well as communication between platform 100 and providers 600. End user context component 104 serves as a container for current activities and associated history representing the dialogue between and among these entities. The information contained in end user context component 104 includes the following general categories of information: marketing information; outstanding issues (e.g., e-mail follow up items); action items (e.g., payments due, certificate lapse); activity log; and activities initiated by the end user 500.

Directory component 105 contains profile information of end users 500 as well as device information. The profile information included in directory component 105 comprises various types of end user 500 information that is associated with a non-externally identifying symbol of the end user 500, also referred to herein as a global universally unique identifier (“GUID”). Each end user 500 has at least one GUID associated with him or her. Some end users have more than one GUID, in some embodiments. There are, in the preferred embodiment, three general categories of information of the end user 500 associated with the GUID: public information (e.g., the common name of the end user 500 as well as their preferred language, locale, and preferred path of contact); private information (e.g., the first and last name of the end user 500, their address, telephone number, and marital status); and provider preference information (e.g., certain preferences of end user 500 for each service 650 offered by provider 600. The device information may include the serial number identification of the device, the device type, device state (active or inactive), and identification of the access provider associated with the device. Providers 600 may access directory component 105 (using number manager 220 as described in more detail above) to perform a variety of functions relating to devices and end users 500. In particular, a provider 600 can update, add or remove end user information or device information.

Platform 100 also includes wallet component 110. Wallet component 110 stores the financial profile information of end users 500, which facilitates purchasing opportunities if desired by the user. Wallet component 110 comprises specialized profile attributes representing the payment vehicles of end user 500, together with their associated authorization credentials.

Platform 100 includes numbers cache component 107. Numbers cache component 107 is used to store lists of numbers inputted by end user 500. In particular, this component is a list-based history of the number inputting activity of the end user 500. The number cache component 107 supports the functionality offered to end users 500 via the end user GUI 210. For example, end users 500 employing end user GUI 210 may access the functionality of numbers cache component 107 to manipulate lists of numbers. An end user 500 may store a list of numbers to number cache component 107. Numbers lists may also be deleted using this component.

Number profile component 108 stores information about numbers and the applications associated with the numbers. In general, the filtering functionality of platform 100 uses number profile component 108 to take a number (inputted by an end user 500 by, for example, key-entry, voice or scanning) and direct the user to information associated with the number via a URL. In particular, number profile component 108 uses active operational mapping from a number inputted by an end user 500 and, in some embodiments, profile information of the end user 500 (including preferences and any services to which the end user 500 has subscribed) from directory component 105; device profile information of the device used to input the number (including ownership information and any restrictions placed on usage) from directory component 105; and context information (i.e., property information of a session of the end user 500 on the network 2000) to return to the end user 500 pointers to the specific information desired by end user 500 within the particular service/application 650.

Number catalog component 109 handles information, life cycle, and ownership properties for numbers, services, and their respective mappings. In particular, number catalog component 109 allows for the linking of numbers to services/applications 650. Number catalog component 109 allows for the creation of new services/applications by providing parameters such as URL, title and description. The provider 600 may specify service contexts, as well as specify, and narrow, the items displayed to a user based on a particular number, alter the size of the content returned, and/or alter the starting point for the list of items returned to the user. For example, it may be specified that only end users 500 with a particular context be allowed to use a certain service (e.g. users that input numbers via a cellular telephone may not be allowed to obtain access to information or services that include graphics). Number catalog component 109 also allows for the creation of operational accounts, which specifies ownership of services, lists, contexts, and numbers.

Content catalog component 111 serves as a repository and loading facility for product information. Content catalog component 111 is used to supply product information to number catalog component 109 that is too volatile or large to store in the number catalog component 109.

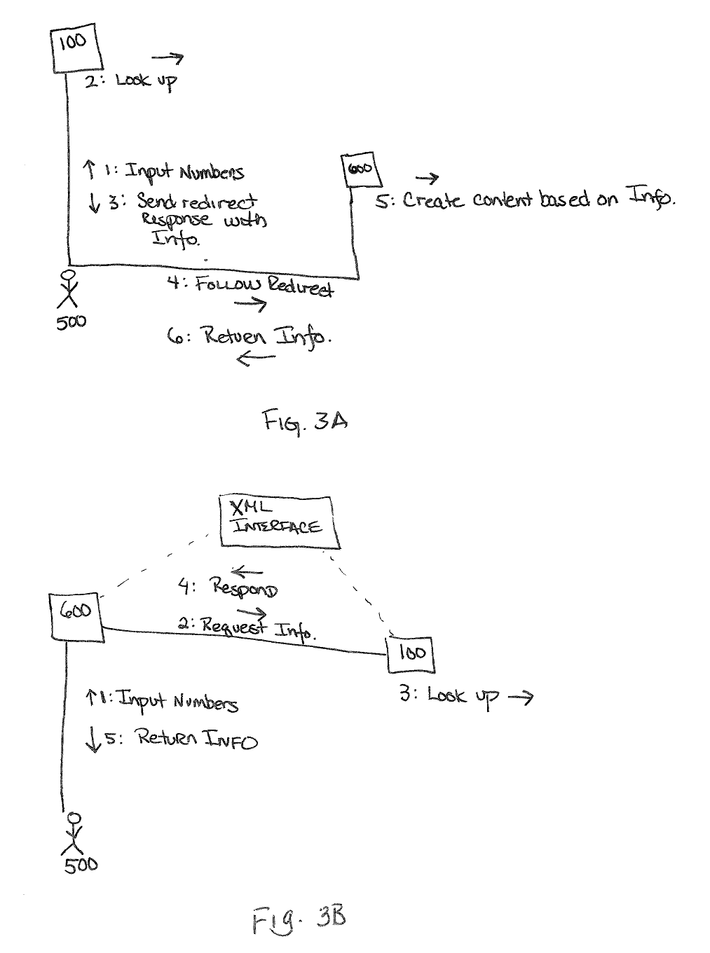

FIGS. 3A and 3B illustrate two examples of the way in which information may flow among an end user 500, the platform 100, and providers 600 of FIG. 2. With reference to FIG. 3A, in step 1, end user 500 inputs numbers and transmits them to platform 100. In step 2, platform 100 looks up the application and, in some embodiments, specific information associated with the numbers and, in step 3, sends end user 500 a redirect response to the provider 600 with the information. In step 4, end user 500 follows the redirect to provider 600. In step 5, provider 600 creates content based on the information and returns the content to end user 500, in step 6. With reference to FIG. 3B, end user 500 inputs numbers and transmits them in step 1 to provider 600. In step 2, provider 600 requests information from platform 100, which looks up the numbers in step 3. In step 4, platform 100 responds to provider 600 with the information. In step 6, provider 600 returns information to end user 500. Other information flows will be known to those skilled in the art and are within the scope of the present invention.

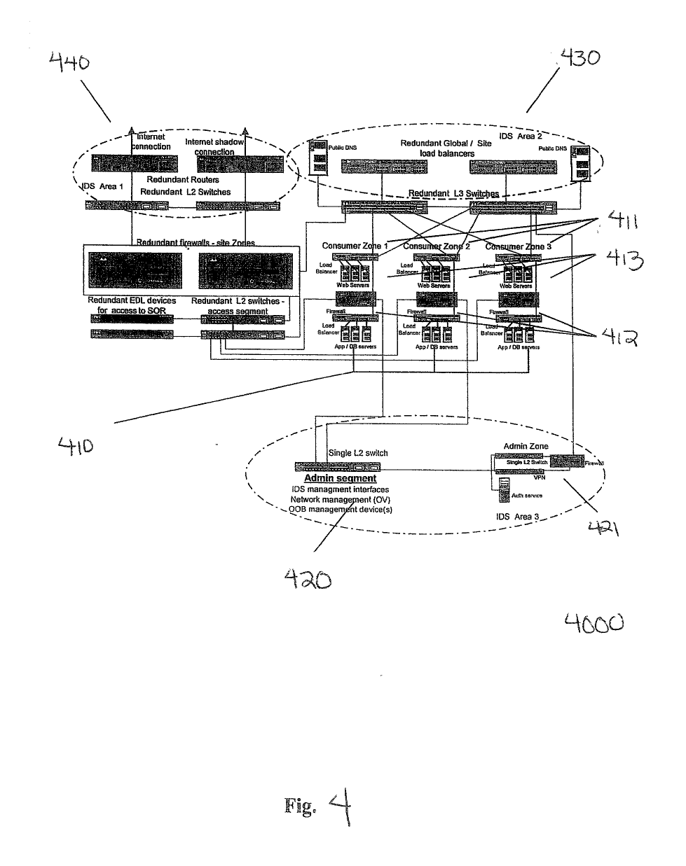

FIG. 4 provides an example of a preferred embodiment of a system 4000 that may be used to implement the methods of the present invention. Calls made by end users 500 through the end user GUI 210 or connected window™ GUI 211 (described with reference to FIG. 2, for example) may be satisfied by consumer zones 410, each of which includes web servers 411 and application servers 412. Each consumer zone 410 also includes fire walls 413. While this exemplary embodiment depicts three consumer zones 410, any number of consumer zones may be employed, as needed, in accordance with the present invention. Thus, system 400 is scalable. Administrative segment 420 satisfies calls made through account manager 230 and number manager 220, as described with reference to FIG. 2. Authentication of end users may also be carried out through authentication service 421 of administrative segment 420. Statement of record area 430 provides back up of all the information maintained on platform 100 (described with reference to FIG. 2) and, thus, should be highly secure. Internet access to system 4000 can be achieved through internet connection segment 440.

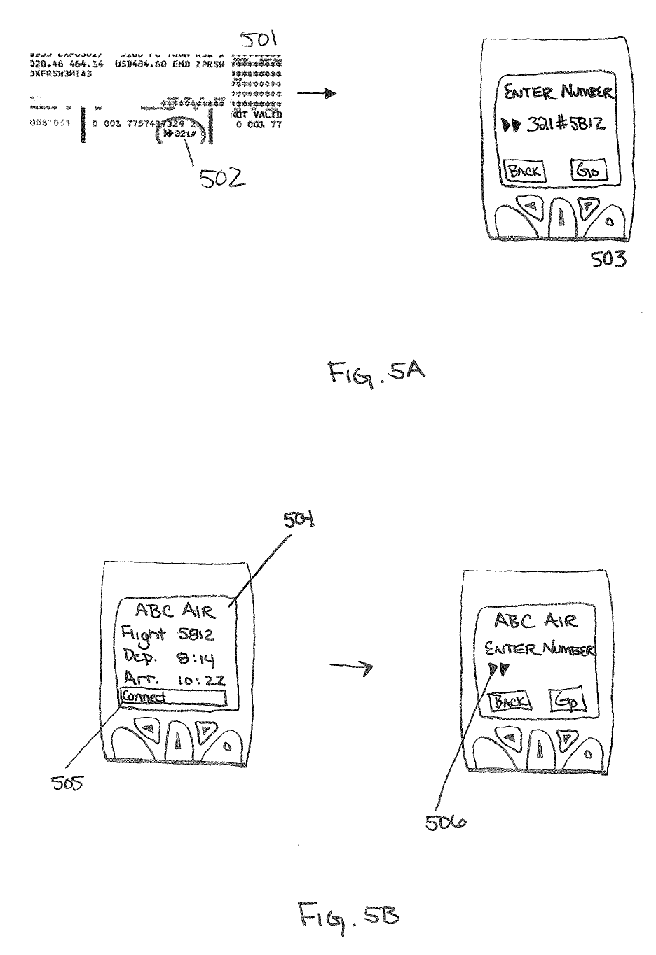

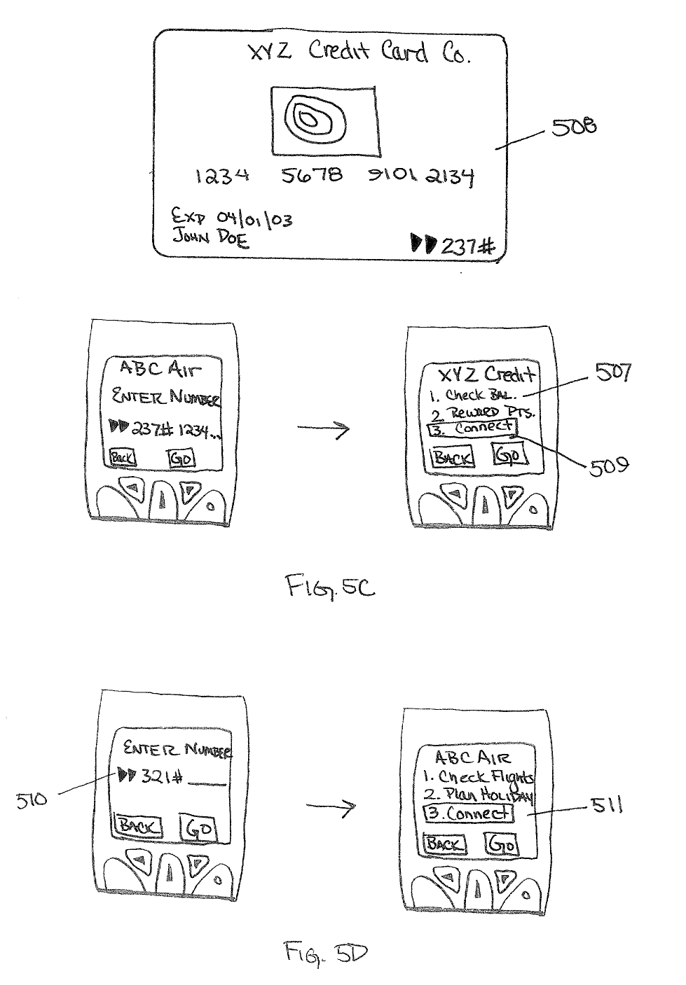

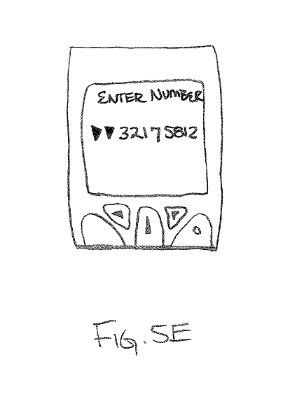

An example of the way in which the systems of the present invention can be used are illustrated with reference to FIG. 5A through FIG. 5E. With reference to FIG. 5A, a portion of an airline ticket 501 is shown. An exemplary service number 502—in this case 321—is printed at the bottom corner of the airline ticket 501, indicating that the service number for this particular airline is 321. A user may employ mobile phone 503 (a portion of which is shown) with wireless web service to access, for example, hub site 101 through end user GUI 210 (represented in FIG. 2). Alternatively, the user may access hub site 101 through a connected window™ GUI 211 found by the user somewhere on network 2000 (shown with reference to FIG. 1A and FIG. 2). The user enters the service number (i.e. 321) and the flight number (in this example, 5821) separated by a delimiter (i.e., the pound sign) and is automatically transported to the airline's wireless web site page 504, where the user is presented with the options that pertain to flight 5821 (e.g., arrivals, departures, destination weather etc.), as shown in FIG. 5B.

At web site page 504, the user's selection of connect button 505 will present to the user connected window™ entry area 506 (i.e., a particular manifestation of connected window™ GUI 211 of FIG. 2). Using connected window™ entry area 506, the user may obtain other information, such as the user's credit card balance. For example, with reference to FIG. 5C, the user may enter the service number associated with the user's credit card (in this case, 237 as printed on the user's credit card 508), a delimiter (in this case, a pound sign), and the user's credit card number (in this case, 1234XXXXXXXX). The user is then automatically transported to the credit card company's wireless web site page 507 at a point listing detailed options that apply to the cardholder associated with the inputted account number (e.g., check a balance, check reward points etc.).

From here, the user may again select connect button 509 and be presented with connected window entry area 510, with reference to FIG. 5D. Here, the user may again enter the service number associated with the airline (i.e. 321) and be transported to a wireless web site page 511 associated with the airline. FIG. 5E illustrates the user input of the airline service number along with the flight number, separated by a numeric delimiter (in this case, the number 7). Based on the fact that the user visited the airline web site recently to check a flight, the airline may present the user with options relevant to other needs they may want to satisfy, such as booking other flights.

The example described with reference to FIG. 5A through FIG. 5D can be accomplished using end user client 15 (shown in FIG. 1A) instead of a WAP enabled phone. In that case, the user interface is that of the user's personal computer rather than of the user's phone. Otherwise, the user experience is basically the same.

As users move from one site to another using a connected window™, providers sponsoring the connected window™ on their sites may share information about the end user and his activities within the network 2000. Also, session management allows providers sponsoring a connected window™ to guide users out to other sites and back to their own sites in meaningful, non-intrusive ways. Use of the systems and methods of the present invention also allows providers to gain access to a wide variety of users who might not normally visit their site in a single session.

In other examples, a user may call a telephone number to access information. The user may be given the option to input into the telephone a service number and identification number under a specific prompt. Upon doing so, platform 100 will match the service number and identification number inputted by the user with the corresponding application and specific information, and transfer the user to the appropriate phone site.

In some embodiments, if the user enters an identification number without a preceding service number, the user may be presented with a list of possible applications to which the identification number may correspond. For example, with reference to FIG. 2, an identification number entered by an end user 500 at connected window™ GUI 211 will be stored in numbers cache component 107. Numbers profile component 108 is consulted to determine what applications, if any, can use the identification number entered. All or some of the applications that may use the identification number will be presented to end user 500. In other circumstances, if the identification number is relevant to an application corresponding to the site at which the identification number was entered, the user may be directed to the point on that site to which the identification number is assigned. In still other circumstances, a user may input a portion of the service number, along with the identification number. In this case, the user will be presented with a menu of possible choices for services within the field indicated by the portion of the service number and the identification number inputted.

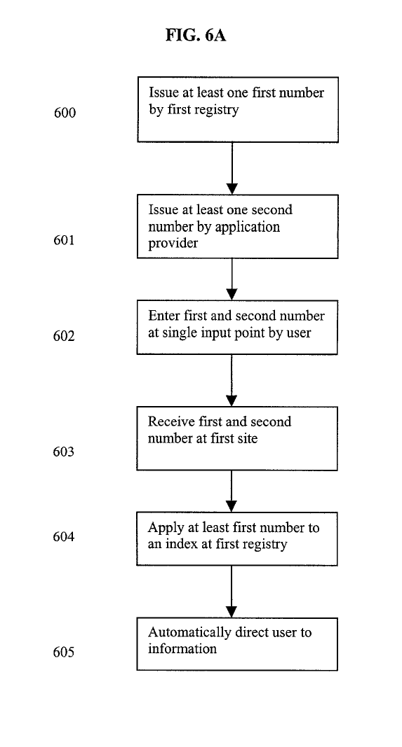

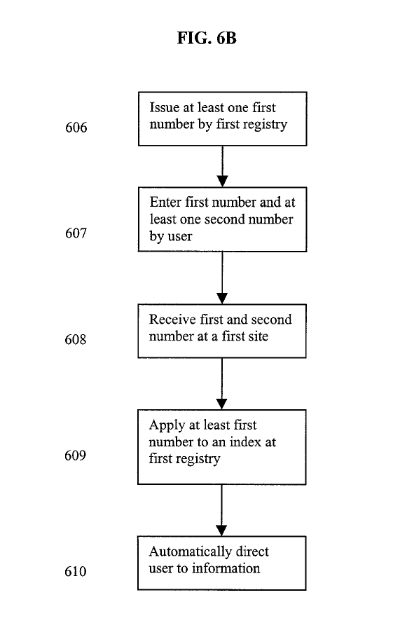

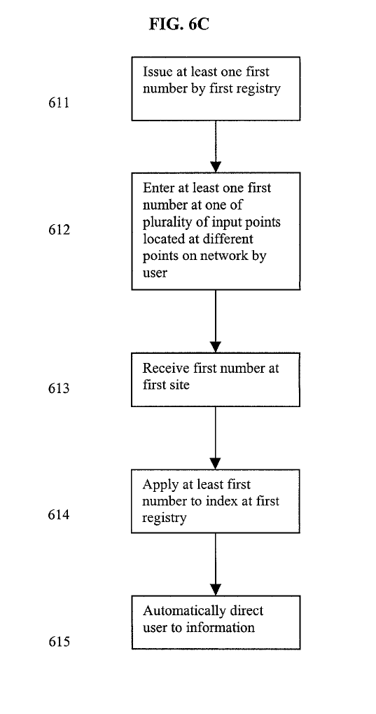

Preferred embodiments of methods for directing a user to information specific to an application on a network are illustrated with reference to FIGS. 6A through 6C. With reference to FIG. 6A, in step 600, at least one first number uniquely identifying the application on the network is issued by an entity that maintains a first registry (e.g., platform 100 of FIG. 1) of first numbers uniquely identifying applications on the network. In step 601, at least one second number is issued by an application provider. In step 602, the first number and the second number are entered by the user at a single point of input (in one or more steps). In step 603, the first and second numbers are received at a first site. In step 604, at least the first number is applied to an index maintained at the first registry to identify a location of the application on the network. In step 605, the user is automatically directed to the information based on the combination of the first number and the second number by applying an output of the first registry to a second registry.

With reference to FIG. 6B, in step 606, at least one first number uniquely identifying the application on the network is issued by an entity that maintains a first registry of first numbers uniquely identifying applications on the network. In step 607, the first number and at least one second number associated with the information are entered by the user at one of a plurality of input points located at different locations on the network. In step 608, the first number and second number are received at a first site. In step 609, at least the first number is applied to an index maintained at the first registry to identify a location of the application on the network. In step 610, the user is automatically directed to the information based on the combination of the first number and the second number by applying an output of the first registry to a second registry.

With reference to FIG. 6C, in step 611, at least one first number uniquely identifying the application on the network is issued by an entity that maintains a first registry of first numbers uniquely identifying applications on the network. In step 612, a user enters at least one first number at one of a plurality of input points located at different locations on the network. A provider offering the application is required to host at least one of the input points on a provider site. In step 613, the first number is received at a first site. In step 614, at least the first number is applied to an index maintained at the registry to identify a location of the application on the network. In step 615, the user is automatically directed to the information based on the user input by applying an output of the first registry to a second registry.

With regard to the methods illustrated in FIGS. 6A through 6C, the second registry (e.g. a DNS) is different from the first registry (e.g., platform 100).

Service numbers, identification numbers and the connected window™ of the present invention can be employed in any number of contexts, in addition to those specifically identified herein, within the scope of the present invention. For example, auto dealerships can use VIN numbers to link drivers to service updates. Telephone numbers can be used as identification numbers, in combination with a particular service number, to direct users to a specific department within an organization. Social security numbers can be used to link citizens to government services. Each of these examples provide users with a standard way of accessing the information they desire and provide businesses with a more efficient way of reaching their customers and prospects.

The present invention may be embodied in other specific forms without departing from the spirit or essential attributes of the invention. Accordingly, reference should be made to the appended claims, rather than the foregoing specification, as indicating the scope of the invention.

What is claimed is:

1. A method for directing a user to information specific to an application on a network comprising:
(a) receiving at a first site at least one first number uniquely identifying the application on the network, the at least one first number being issued by an entity that maintains a first registry of first numbers uniquely identifying applications on the network, and at least one second number associated with the information, the at least one second number being issued by an application provider,
wherein the at least one first number and the at least one second number are entered by the user at a single point of input;
(b) applying at least the first number to an index maintained at the first registry to identify a location of the application on the network; and
(c) automatically directing the user to the information based on a combination of the at least one first number and the at least one second number by applying an output of the first registry to a second registry,
wherein the second registry is different from the first registry.

2. The method of claim 1 wherein the at least one first number comprises at least one first digit representing an industry and at least one second digit representing an organization within the industry.

3. The method of claim 1 wherein the at least one first number and the at least one second number are separated by a delimiter.

4. The method of claim 3 wherein the delimiter is a single numeric digit.

5. The method of claim 1 wherein the first number and the second number are entered by the user in a single input.

6. A method for directing a user to information specific to an application on a network comprising:
(a) receiving at a first site at least one first number uniquely identifying the application on the network, the at least one first number being issued by an entity that maintains a first registry of first numbers uniquely identifying applications on the network, and at least one second number associated with the information entered by the user at one of a plurality of input points located at different locations on the network;
(b) applying at least the first number to an index maintained at the first registry to identify a location of the application on the network; and
(c) automatically directing the user to the information based on a combination of the at least one first number and the at least one second number by applying an output of the first registry to a second registry,
wherein the second registry is different from the first registry.

7. A method for directing a user to information specific to an application on a network comprising:
(a) receiving at a first site a user input comprising at least one first number uniquely identifying the application on the network, the at least one first number being issued by an entity that maintains a first registry of first numbers uniquely identifying applications on the network, entered by the user at one of a plurality of input points located at different locations on the network,
wherein a provider offering the application is required to host at least one of the input points on a provider site;
(b) applying at least the first number to an index maintained at the first registry to identify a location of the application on the network; and
(c) automatically directing the user to the information based on the user input by applying the output of the first registry to a second registry,
wherein the second registry is different from the first registry.

8. A system for directing a user to information specific to an application on a network comprising:
at least one first site that receives at least one first number uniquely identifying the application on the network, the at least one first number being issued by an entity that maintains a first registry of first numbers uniquely identifying applications on the network; receives at least one second number associated with the information, the at least one second number being issued by an application provider, wherein the at least one first number and the at least one second number are entered by the user at a single point of input; wherein at least the first number is applied to an index maintained at the first registry to identify a location of the application on the network; and wherein the user is automatically directed to the information based on a combination of the at least one first number and the at least one second number by applying an output of the first registry to a second registry,
wherein the second registry is different from the first registry.

9. The system of claim 8 wherein the at least one first number comprises at least one first digit representing an industry and at least one second digit representing an organization within the industry.

10. The system of claim 8 wherein the at least one first number and the at least one second number are separated by a delimiter.

11. The system of claim 10 wherein the delimiter is a single numeric digit.

12. The system of claim 8 wherein the first number and the second number are entered by the user in a single input.

13. A system for directing a user to information specific to an application on a network comprising:
at least one first site that receives at least one first number uniquely identifying the application on the network, the at least one first number being issued by an entity that maintains a first registry of first numbers uniquely identifying applications on the network, and at least one second number associated with the information, entered by the user at one of a plurality of input points located at different locations on the network; wherein at least the first number is applied to an index maintained at the first registry to identify a location of the application on the network; and wherein the user is automatically directed to the information based on a combination of the at least one first number and the at least one second number by applying an output of the first registry to a second registry,
wherein the second registry is different from the first registry.

14. A system for directing a user to information specific to an application on a network comprising:
at least one first site that receives a user input comprising at least one first number uniquely identifying the application on the network, the at least one first number being issued by an entity that maintains a first registry of first numbers uniquely identifying applications on the network, entered by the user at one of a plurality of input points located at different locations on the network, wherein a provider offering the application is required to host at least one of the input points on a provider site; wherein at least the first number is applied to an index maintained at the first registry to identify a location of the application on the network; and wherein the user is automatically directed to the information based on the user input by applying an output of the first registry to a second registry,
wherein the second registry is different from the first registry.
